(19) United States
(12) Patent Application Publication
(10) Pub. No.: US 2018/0082363 A1
(43) Pub. Date: Mar. 22, 2018

(54) Online auction platform for invoice purchasing

(71) Applicant: Per Frennbro, London (GB)

(72) Inventor: Per Frennbro, London (GB)

(21) Appl. No.: 15/731,717

(22) Filed: Jul. 24, 2017

Related U.S. Application Data
(60) Provisional application No. 62/395,414, filed on Sep. 16, 2016.
(60) Provisional application No. 62/463,683, filed on Feb. 26, 2017.
(60) Provisional application No. 62/525,914, filed on Jun. 28, 2017.

(51) Int. Cl. G06Q 30/08; G06Q 40/08

(52) U.S. Cl. CPC G06Q 30/08; G06Q 40/08

(57) ABSTRACT

A method for selling invoices includes: providing an online marketplace between buyers and sellers of commercial invoices; receiving an invoice uploaded by a seller of the invoice; notifying a buyer of goods and/or services named in the uploaded invoice of the sale; arranging trade credit insurance between the seller and a trade credit insurer; conducting an auction for the purchase of the invoice among one or more buyers; ending the auction and collecting cash proceeds of a sale of the invoice from one or more winning buyers of the invoice having the lowest interest yields for their bids; retaining at least one sales commission from the cash proceeds; paying an insurance premium to the trade credit insurer; and paying a portion of the cash proceeds to the seller.

### CROSS-REFERENCE TO RELATED APPLICATIONS

This application claims the benefits of U.S. provisional patent applications, Ser. No. 62/395,414, filed on Sep. 16, 2016, Ser. No. 62/463,683, filed on Feb. 26, 2017, and Ser. No. 62/525,914, filed on Jun. 28, 2017, which are incorporated herein by reference in their entireties.

### FIELD OF THE INVENTION

The present invention relates to commercial financing, and more particularly to selling of invoices and receivables.

### BACKGROUND OF THE INVENTION

Cash flow is the life blood of any business. Cash flow is the net amount of cash and cash-equivalents moving into and out of a business. Positive cash flow indicates that a company's liquid assets are increasing, enabling it to settle debts, return money to shareholders, pay expenses and provide a buffer against future financial challenges. Negative cash flow indicates that a company's liquid assets are decreasing. Net cash flow is distinguished from net income, which includes accounts receivable and other items for which payment has not actually been received. Cash flow is used to assess the quality of a company's income, that is, how liquid it is, which can indicate whether the company is well positioned to remain solvent.

Cash flow is critical to any business, but smaller businesses are far more sensitive to interruptions in cash flow than larger businesses. Smaller businesses don't have large cash and credit reserves to withstand significant interruptions in cash flow, so many small businesses sell their receivables to bring in cash quicker than a customer is able to pay an invoice. However, for most small businesses wishing to sell their outstanding invoices and related receivables the market do not offer a fast safe and effective solution. Typically, the consequences forced upon small businesses wishing to sell invoices makes the sale unacceptable, and cash flow suffers as the direct result.

### SUMMARY OF THE INVENTION

The present invention provides an auction platform for invoices within invoice financing for small and medium sized enterprises where the buyer of an invoice can advance cash against all or part of an invoice. The auction platform is, in an embodiment, implemented as a web site where invoices are uploaded and auctioned via manual or automated bids. In an embodiment, the operator of the website does not take ownership of any part of an invoice and does not co-fund any invoice purchases. Trade credit insurance is provided by a third-party insurer in an embodiment.

On the one hand, the present invention provides a method for auctioning invoices by providing an online marketplace between buyers and sellers of commercial invoices; receiving an invoice uploaded by a seller of the invoice; sending an electronic communication to a buyer of goods and/or services (BOG) named in the uploaded invoice requesting confirmation of the invoice and approval of its sale on the online marketplace; receiving confirmation of the invoice and approval of the sale of the invoice from the buyer of goods and/or services named in the uploaded invoice; verifying that the invoice is not used for money laundering and verifying identities of the seller and BOG referenced by the invoice; arranging trade credit insurance between the seller and a trade credit insurer; conducting an auction for the purchase of the invoice among one or more buyers; conducting the auction and collecting cash proceeds of a sale of the invoice from one or more winning buyers of the invoice; retaining at least one sales commission from the cash proceeds; paying an insurance premium to the trade credit insurer; and paying a portion of the cash proceeds to the seller.

When the invoice is paid by the BOG the money is automatically distributed based on the share of the invoice each buyer of the invoice owns.

In an embodiment, an amount from the cash proceeds is withheld from the seller for a period of time and paid to the seller after a payment is made to the seller.

In an embodiment, collecting cash proceeds from one or more winning buyers includes withdrawing cash from a bank account associated with the winning buyer, the bank account funded by the buyer before the buyer bids on an invoice. The bank account can be substituted by any other payment or access method for cash for funding the purchase.

In an embodiment, the invoice received from the seller is received from an accounting program or any invoice produced and controlled by the seller or any other way via an interface to a different system or via manual uploading from the seller.

In an embodiment, a recommendation against a particular seller is determined from a seller's performance history and published to potential buyers.

### BRIEF DESCRIPTION OF THE DRAWINGS

FIG. 1 shows a functional block diagram of an exemplary client-server architecture used in embodiments of the present invention.

FIG. 2 shows an operative sequence of steps executed to practice the method of the present invention.

FIG. 3 shows in diagrammatic form a reverse auction as utilized in FIG. 2.

FIG. 4 shows a functional user interface provided to sellers of invoices.

FIG. 5 shows a functional user interface provided to buyers of invoices.

### DETAILED DESCRIPTION

A buyer of an invoice is defined herein as a limited company or belongs to the categories of self-certified partnerships or retail customers. A seller of an invoice is defined herein as an any type of entity, and is the producer of goods and/or services referenced by the invoice to be sold. Cost is the agreed price that the seller pays the buyer for a portion of an invoice or all of an invoice. The buyer “buys” the invoice but in essence it is a cost to the seller since the invoice is financed by the buyer's cash advancement. Cost also refers to the amount of cash that is forwarded immediately to the seller upon purchase of all or part of an invoice. Commission is defined herein as a fee that a seller pays to the operator of the website to contract with buyers to sell the invoice and receive cash from buyers upon a sale of an invoice in part or in whole. A BOG is defined herein as a buyer of goods and/or services and the payer of the invoice related to the goods and/or services provided by the seller to the BOG. Upon signing up for participation on the auction platform of the present invention, sellers and buyers agree to terms and conditions set by the operator of the website that include, among other requirements, that upon a finalized auction, ownership of a portion or the entirety of an invoice transfers from the seller to the buyer. Terms and conditions agreed to by the buyer and the seller also are incorporated into the sales contract between them.

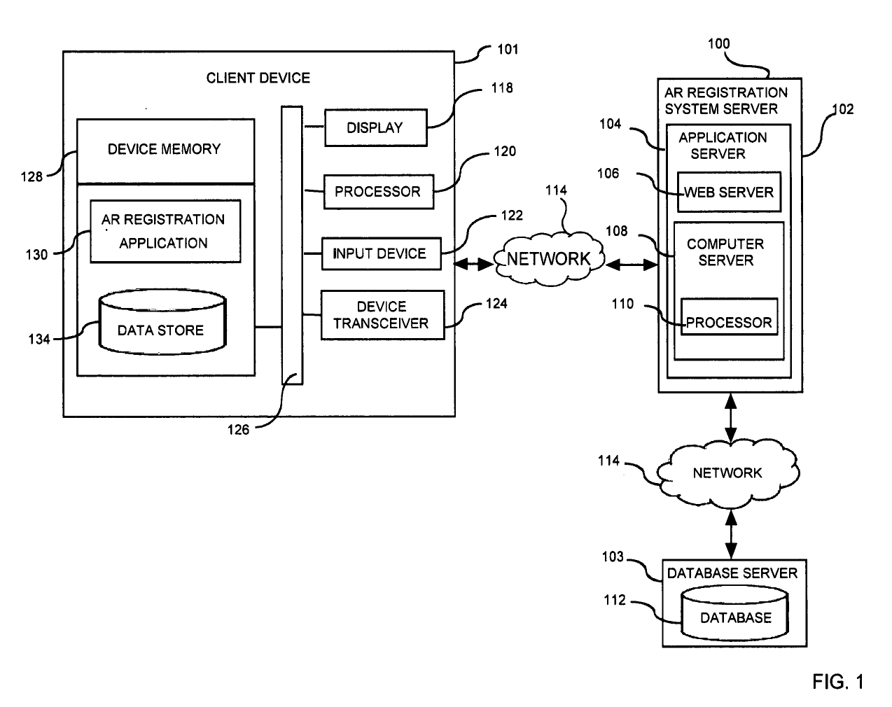

FIG. 1 illustrates the general architecture of a client-server system 100 that operates in accordance with embodiments of the present invention to enable users of the app of the present invention using a client device to communicate with the system. In a preferred embodiment, system 100 is implemented in multi-tier or n-tier architecture with one or more client devices 101, controlled by users residing at the client tier, one or more system servers 102 in the middle or server application tier and one or more database servers 103 residing in the database tier. In the above variant of three-tier architecture, the client, the first tier, may have to only perform the user interface i.e., validate inputs; in which case the middle tier holds all the backend logic and does data processing while the data server, the third tier, performs data validation and controls the database access.

One or more client devices 101 are connected to access request (AR) system server 102 via a network 114. The system server 102 communicates with the client devices 101 over the network 114 to present a user interface or graphical user interface (GUI) for system 100 of the present invention. The user interface of system 100 of the present invention can be presented through a web browser or through a mobile application communicating with the system server 102 and is used for displaying, entering, publishing, and/or managing data required for the service. As used herein, the term “network” generally refers to any collection of distinct networks working together to appear as a single network to a user. The term also refers to the so-called world wide “network of networks” or Internet which is connected to each other using the Internet Protocol (IP) and other similar protocols. As described herein, the exemplary public network or cloud 114 of FIG. 1 is for descriptive purposes only and it may be wired or wireless. Although the description may refer to terms commonly used in describing particular public networks such as the Internet, the description and concepts equally apply to other public and private computer networks, including systems having architectures dissimilar to that shown in FIG. 1. The inventive idea of the present invention is applicable for all existing cellular network topologies or respective communication standards, in particular GSM, UMTS/HSPA, LTE and the like. With respect to the present description, the system server 102 may include any service that relies on a database system that is accessible over a network, in which various elements of hardware and software of the database system may be shared by one or more users of system 100. To this end, the users of the client device 101, from which a request or instruction is received over a network 114, may include any individual customer. The GUI or user interface provided by the system server 102 on the client devices 101 through a web browser or mobile app may be utilized by the users for utilizing system 100 to buy and sell invoices on system server 102.

The components appearing in the server 102 refer to an exemplary combination of those components that would need to be assembled to create the infrastructure in order to provide the tools and services contemplated by the present invention. As will be apparent to one skilled in the relevant art(s), all of components “inside” of the server 102 may be connected and may communicate via a wide or local area network (WAN or LAN).

Server 102 includes an application server or executing unit 104. The application server or executing unit 104 comprises a web server 106 and a computer server 108 that serves as the application layer of the present invention. The web server 106 is a system that sends out web pages, such as screens 1-5 described above, containing electronic data files in response to Hypertext Transfer Protocol (HTTP) requests from remote browsers (i.e. browsers installed in the client devices 101) or in response to similar requests made through a mobile app or mobile application of the present invention installed on a client device 101. The web server 106 can communicate with the mobile application of the present invention and/or with a web browser installed on a client device 101 to provide the user interface required for the service. Similarly, web server 106 also communicates with state controller computer systems on behalf of users of client devices 101 to facilitate return of unclaimed property owed to the user.

The computer server 108 may include a processor 110, a Random Access Memory (RAM) (not shown in figures) for temporary storage of information, and a Read Only Memory (ROM) (not shown in figures) for permanent storage of information. Computer server 108 may be generally controlled and coordinated by operating system software. The operating system controls allocation of system resources and performs tasks such as processing, scheduling, memory management, networking, and I/O services, among (other) things. Thus, the operating system resides in system memory and, on being executed by a processor such as a CPU, coordinates the operation of the other elements of system server 102.

Although the description of the computer server 108 may refer to terms commonly used in describing particular computer servers, the description and concepts equally apply to other processing systems, including systems having architectures dissimilar to that shown in FIG. 1.

The database tier is the source of data where at least one database server 103 generally interfaces multiple databases 112. Those databases are frequently updated by their users and administrators most often through a combination of private and public networks 114 including the Internet. It would be obvious to any person skilled in the art that, although described herein as the data being stored in a single database, different separate databases can also store the various data and files of multiple users.

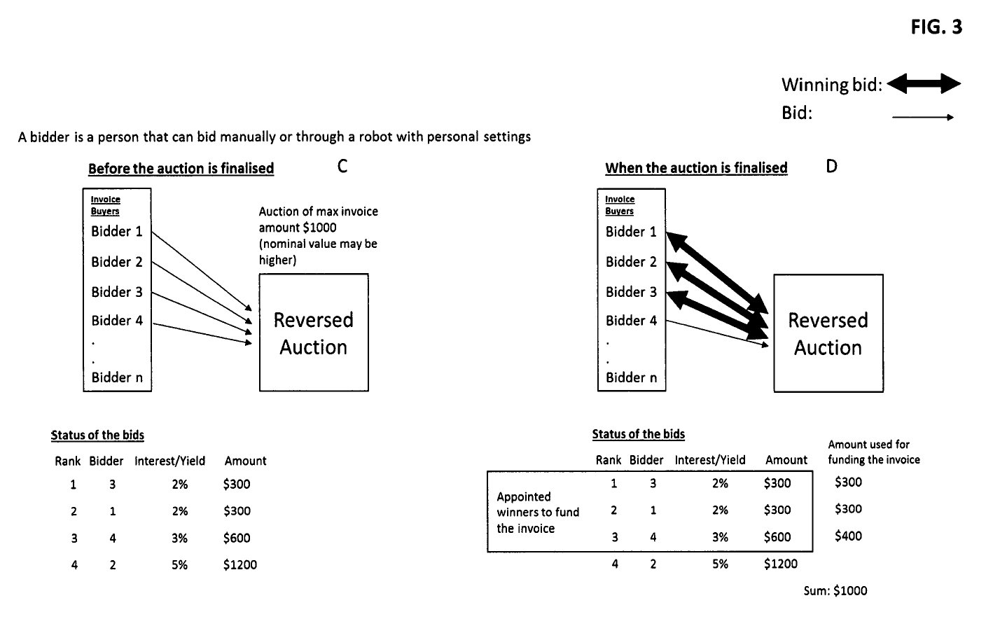

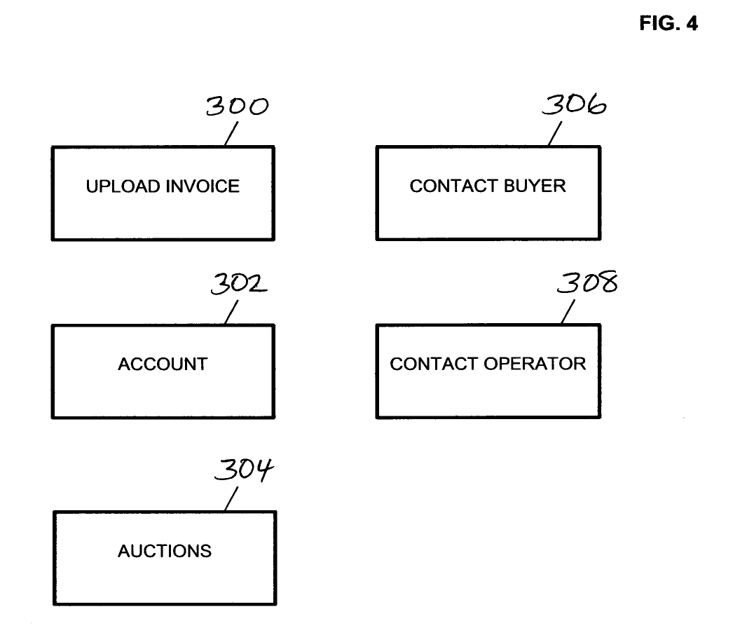

A mobile application, or “app” as described above, is a computer program that may be downloaded and installed in client device 101 using methods known in the art. Hereinafter, the mobile app 130 is referred to as Access Request (AR) app 130. App 130, custom built for the present invention, enables one or more persons to view screens 1-5 described above and to do various tasks related to functions of system server 102 described above. The activities related to the service of the present invention can also be performed using the user interface (or GUI) presented through a client device based web browser. Hereinafter, the term “user interface” is used to refer to both app user interface and the web browser user interface of the present invention, and is illustrated in FIGS. 3 and 4. Examples of client device 101 may include, but not limited to, mobile devices, tablets, hand-held or laptop devices, smart phones, personal digital assistants, desktop computers, wearable devices, AR glasses, VR headsets, or any similar device.

As illustrated in FIG. 1, the client device 101 may include various electronic components known in the art for this type of device. In this embodiment, the client device 101 may include a device display 118, a computer processor 120, a user input device 122 (e.g., touch screen, keyboard, microphone, and/or other form of input device known in the art), a device transceiver 124 for communication, a device memory 128, the AR app 130 operably installed in the computer memory 128, a local data store 134 also installed in the device memory 128, and a data bus 126 interconnecting the aforementioned components. For purposes of this application, the term “transceiver” is defined to include any form of transmitter and/or receiver known in the art, for cellular, WIFI, radio, and/or other form of wireless or wired communication known in the art. Obviously, these elements may vary, or may include alternatives known in the art, and such alternative embodiments should be considered within the scope of the claimed invention.

When a company synchronizes their accounting system to the platform, the present invention analyses the imported information and decides if the company is approved from a financial point of view to do invoice financing through the platform. The analysis contains fraud detection, financial results, aging of invoices and many key performance indicators that would be value the financial status in the company. The analysis does based on this then decide whether the credit risk is on par with the publicly available other parties provide about the company. The analysis also may include analyzing companies that have a shorter history than a year of performance and can from this decide whether the financial situation is sufficient for invoice financing.

In an embodiment, verification occurs in two steps. When it is onboarded to the present invention, the first step is to verify that the company exists and has sufficient financial capability to receive invoice financing. After having selected or uploaded the invoice, the second step is to again verify that the company is solid and has not entered into bankruptcy.

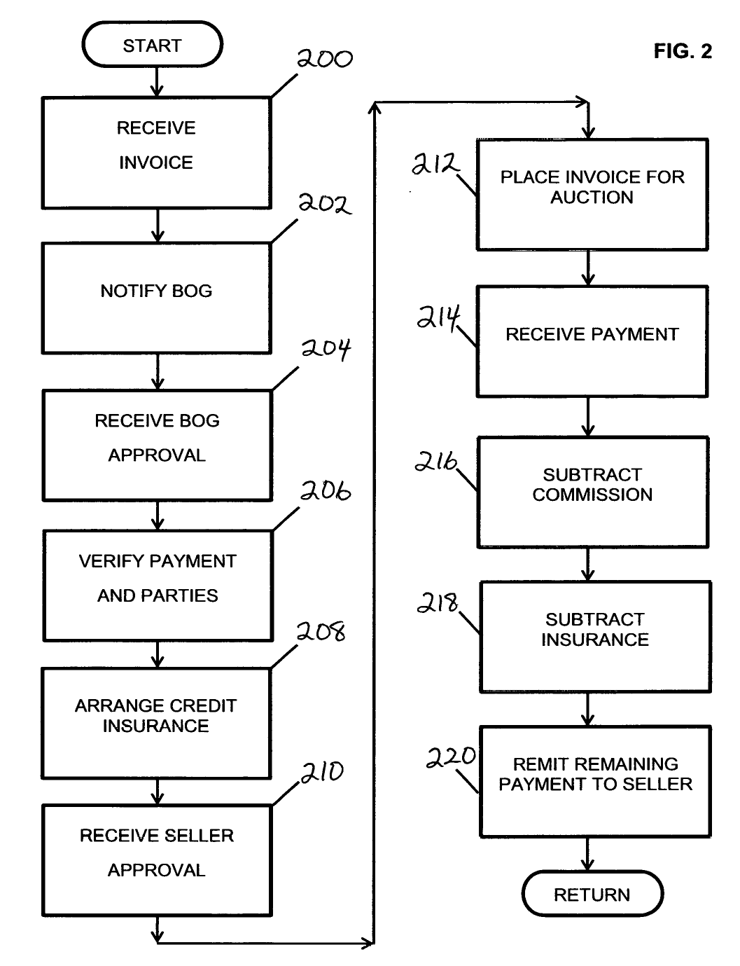

FIG. 2 is a flow chart of operative steps executed by server 102 of system of the present invention. Beginning at step 200, server 102 receives an invoice uploaded by a seller. Uploading the invoice can be a manual process, where a human operator at the seller's location selects an invoice to be uploaded and passes it to server 102 using client device 101, or it can be an automated process, wherein an accounting system controlled by the seller is connected to server 102 and automatically uploads invoices to server 102. The automated process can occur whenever an invoice is created, or in batch mode when a threshold cost amount is satisfied, either in a single invoice or collectively in multiple invoices. In various embodiments, the automated process occurs periodically, such as when a threshold number of invoices have been created, or whenever outstanding invoices pass a specified age threshold.

Upon receiving an uploaded invoice, at step 202, the server 102 sends an electronic communication, such as an email, text, automated telephone call, or other suitable communication to the BOG identified in the uploaded invoice. The BOG is requested to approve the uploaded invoice, confirming quality and/or quantity of goods and/or services received from the seller. The BOG is also requested to confirm agreement to pay a buyer if and when the invoice sells. The electronic communication also states any new payment terms, and in some embodiments relaxes original payment terms to incentivize agreement from BOGs.

At step 204, BOG approval of the sale of the invoice is received by the server 102.

At step 206, server 102 executes anti-money laundering verification procedures as well as customer identification procedures to verify identities of the seller and BOG referenced by the invoice.

At step 208, a transaction for trade credit insurance is arranged between the seller and a trade credit insurer, with the cost of insurance and commission estimated to be paid to the operator of the system of the present invention presented to the seller for approval by electronic message in the form of an email, text message, automated telephone call, or other suitable form of communication.

At step 210, server 102 receives approval from the seller for the auction of the invoice, which includes acceptance and agreement to pay the cost of insurance as well as agreement to pay the commission.

At step 212, the invoice is placed for auction to buyers.

In an embodiment, a reversed auction is conducted among prospective buyers. In a reversed auction, a bidder starts bidding at one level and the other bidders bid lower than the former where it ends up with competing against each other to find the one who has the lowest bid. The principal is to under bid each other to push down the costs for advancing the cash for the seller of the invoice. On this auction it is underbidding the cost that steers the cost level for the seller of the invoice.

Multi winning: The purpose of the auction is to fill up the maximum value on the invoice which is defined as face value less a haircut. As referred to here, a haircut is a safety reduction due to bad credit history or bad payment performance. A haircut is used to prevent losses and can be used to hold back money in case of disputes. Such haircuts can be typically in the range of 5-50% (but not limited to these percentages). This range is typically set based on for example the credit risk, delinquency/paydex scores (willingness to pay) and the financial situation in the company which typically originates in the trust and belief of that the company will pay back. This means the invoice maximum value is typically at the range of 50-95% of the face value of the invoice. This value is targeted to fill up by the bidders, but the bidders can also exceed the maximum value. Then the cost for advancing cash is setting the priorities of the bids in the first instance. In other words, a lower cost for advancing the cash means higher ranking in the reversed auction. If two bids are the same the time stamp of the earlier bid determines who has the higher rank.

If the maximum level is exceeded the bidders with the lowest cost for advancing cash are appointed as winners. This means there are several winners to that will be allowed to advance cash against the invoice. If there are 10 bids on an invoice where three are ranked as the winners and who are the potential bidders that will be allowed to advance cash to the seller of the invoice, but one winner has bid so the bids in total exceeds the maximum level because he has the most costly of the three winners bids, then this winner's bid is reduced so his original value is reduced to fit into the maximum value so that money in excess of the maximum value is not advanced maximum.

Directing attention to FIG. 3, an example of the multiple bidder reverse auction is shown. The maximum value for an auctioned invoice is $1000.

Four bidders bid in this auction. Bidder 1 places a bid for $300 with a 2% interest yield. Bidder 2 places a bid for $1200 with a 5% interest yield. Bidder 3 places a bid for $300 with a 2% yield. Bidder 4 places a bid for $600 with a 3% yield. The total amount bid in this auction is $2400, but the invoice amount is $1000. The auction closes and three winners are appointed: Bidders 3, 1 and 4, because their interest yields are the lowest that satisfy the invoice amount. However, because bidders 3, 1 and 4 have bid a combined about of $1200, Bidder 4's bid is reduced by $200 from $600 to $400.

When the bids are at a level where they are stagnating or when the auction time is up the auction closes with the appointed winner(s) as the funders that advance cash against the invoice. Thus, the auction provides the lowest-cost financing to a seller by securing bids with the lowest interest expense for financing the invoice sold at auction.

For the amount each bidder forward they get ownership directly proportional to the advanced amount of money. The auction model of the present invention is built based on fulfilling the cash need of the seller, pushing down the cost for getting cash advanced from each bidder where the one with the lowest interest yield bid is ranked as number one, next best number two etc. The bidders that have the same cost for advancing the money are prioritized based on the time stamp on the bid, ie the one that has an older time stamp given the same cost is ranked higher than the other ones.

If the total amount for the invoice reaches the required cash advance need, the system of the present invention reduces the bid of the bidder that has highest interest yield so the total amount is always the maximum cash advance need fulfilled.

The bidder can use an automated or robot function to bid or place a bid manually. The seller can use an accept robot to accept the bids. Both robots are set by the seller or buyer of the invoice, following his personal settings for bids and acceptance. The robot is not acting on independently and every user has their own robots to place bids or accept bids and acceptance of the invoices.

The seller does not need to pay back money to the buyer of the invoice if the BOG does not pay the invoice. If the invoice is later determined to be fraudulent, relevant law enforcement agencies are notified. If there is a quality or quantity dispute that arises after the auction, and it cannot be resolved within an agreed or pre-determined period, for example 365 days, a third party collection company is engaged to collect any advanced money from the seller.

Returning to FIG. 2, at step 214, the auction ends and cash proceeds of the sale are received from one or more winning buyers of the invoice. In an embodiment, receiving cash proceeds includes removing the cash from a buyer's bank account or withdrawing the amount from any other payment method.

At step 216, the commission is subtracted from the cash proceeds and retained by operators of server 102 in accordance with the agreement with the seller.

At step 218, an insurance premium is subtracted from the cash proceeds and paid to the insurance provider in accordance with the agreement with the seller.

At step 220, the remaining cash proceeds are paid to the seller.

In an embodiment, an amount from the cash proceeds, referred to herein as a “remainder” can be withheld from the seller for an agreed or pre-determined period of time, for example 30 days from the close of the auction. This period depends on the payment terms set out on the invoice.

Before a buyer may bid on an invoice, the buyer must have deposited a sufficient amount of money to pay for any purchase of an invoice in an bank account or from any other payment method accepted by the operator of server 102. When the auction for an invoice is complete, the buyer orders the release of money bid in the auction from the bank to the seller to complete the transaction. No payment is made to any parties, namely the seller, operator of the system of the present invention, or insurer, until the buyer orders release of cash proceeds from the buyer's bank account via the system of the present invention.

The system of the present invention does not allow an invoice to be partially sold, with a remaining portion owned by the seller. If a seller approves a bid for 63% of the value of an invoice auctioned to buyers, then the entire invoice is sold for 63% of the value of the invoice and full ownership is transferred to the buyer. The ownership of the invoice is always for the full-face value, 100%, of the invoice which also include the legal rights to the invoice and the goods until the invoice is paid in full by the buyer of the goods.

Directing attention to FIG. 4, a simple user interface dashboard is presented by server 102 to sellers is shown. Upon logging into server 102, a seller is presented with various options. Button 300 is labeled “UPLOAD INVOICE” and, when selected, allows a user to upload an invoice for auction. Button 302 is labeled “ACCOUNT” and, when selected, shows the user account balances paid from buyers to the seller, as well as amounts paid to insurers and commissions paid to the operator of server 102. Button 304 is labeled “AUCTIONS” and, when selected, shows invoices uploaded by the seller for auction, start and stop times of auctions, bids placed by various participants listed with dates, times, and amounts, and a breakdown of cash proceed distributions and various financial information Button 306 is labeled “CONTACT BUYER” and, when selected, facilitates communication with a prospective or winning buyer of an uploaded invoice. Button 308 is labeled “CONTACT OPERATOR” and, when selected, facilitates communication with the operator of server 102. Buttons 306 and 308 can utilize written communication, such as email messages, text messages, live messaging and the like, or can establish a live voice and/or video chat between the seller and other relevant parties.

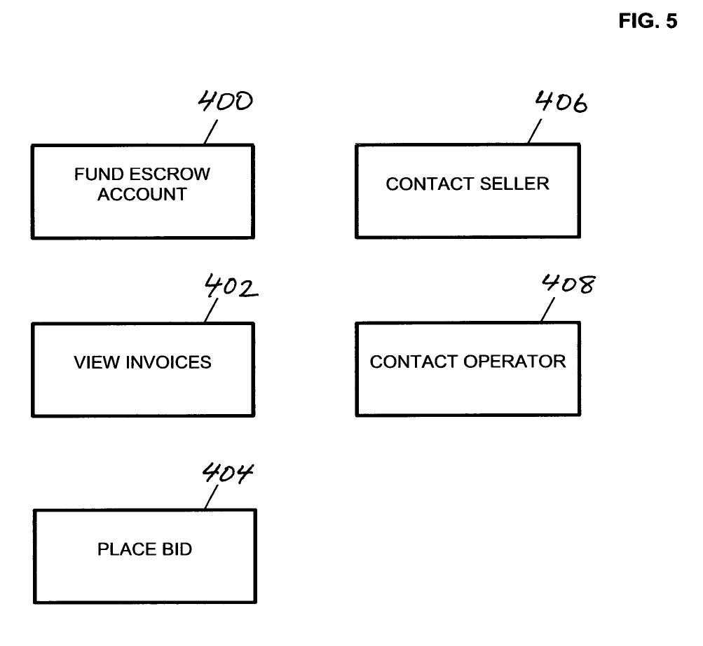

FIG. 5 shows a simple user interface dashboard presented by server 102 to buyers of an invoice. Button 400 is labeled “FUND BANK ACCOUNT” and, when selected, provides a mechanism by which a buyer can remit payment to the operator of server 102. Button 402 is labeled “VIEW INVOICES” and, when selected, allows a buyer to review invoices available for bids. Transaction terms, seller ratings, BOG ratings, and the like, may all be presented for a buyer to view before deciding whether or not to place a bid on an invoice. For example, a recommendation against a particular seller may be made based on seller ratings. In an embodiment, seller ratings are affected by a poor financial situation. The seller allows the system of the present invention to synchronize the financial data in his system where after the system analyze the seller's financial situation and decides if the seller's situation allows different levels of ratings. Button 404 is labeled “PLACE BID” and, when selected, allows a buyer to enter an amount for a bid on a particular invoice available for auction. Button 406 is labeled “CONTACT SELLER” and, when selected, facilitates communication with a seller of an uploaded invoice. Button 408 is labeled “CONTACT OPERATOR” and, when selected, facilitates communication with the operator of server 102.

Buttons 406 and 408 can utilize written communication, such as email messages, text messages, live messaging and the like, or can establish a live voice and/or video chat between the seller and other relevant parties.

While an online auction platform for purchasing of invoices has been described and illustrated in detail, it is to be understood that numerous modifications can be made to the various embodiments of the present invention without departing from the spirit thereof.

What is claimed is:

1. A method for selling invoices, comprising:
providing an online marketplace between buyers and sellers of commercial invoices;
receiving an invoice uploaded by a seller of the invoice;
sending an electronic communication to a Buyer Of Goods and/or services (BOG) named in the uploaded invoice requesting confirmation of the invoice and approval of its sale on the online marketplace;
receiving confirmation of the invoice and approval of the sale of the invoice from the BOG named in the uploaded invoice;
verifying that the invoice is not used for money laundering and verifying identities of the seller and BOG referenced by the invoice;
arranging trade credit insurance between the seller and a trade credit insurer;
conducting an auction for the purchase of the invoice among one or more buyers;
completing the auction and collecting cash proceeds of a sale of the invoice from one or more winning buyers of the invoice;
retaining at least one sales commission from the cash proceeds;
paying an insurance premium to the trade credit insurer; and
seller paying at least a portion of the cash proceeds to the seller based on a ranking in the auction.

2. The method of claim 1, wherein an amount from the cash proceeds is withheld from the seller for a period of time and paid to the seller after an earlier payment is made to the seller.

3. The method of claim 1, wherein collecting cash proceeds from one or more winning buyers comprises withdrawing cash from an bank account associated with a buyer, the bank account funded by the buyer before the buyer bids on an invoice.

4. The method of claim 1, wherein conducting an auction comprises:
placing a receivable in the form of an invoice issued by a seller, the invoice having an amount payable by a buyer of goods or services (BOG) up for auction to a plurality of bidders;
receiving bids for at least part of the amount payable, wherein each bid includes an amount a bidder in the plurality of bidders is willing to provide to the seller as well as an interest yield expressed as a percentage of the amount of the bid that the bidder expects to receive at a future date in addition to the bid amount; and
appointing winners of the auction based on lowest interest yield percentages for bids received that satisfy the amount payable.

5. The method of claim 1, wherein the invoice received from the seller is received from an accounting program controlled by the seller.

6. The method of claim 1, wherein a recommendation is made against the seller based on a performance history attributed to the seller.

7. A computer readable medium containing instructions which, when executed by a processor, sells a commercial invoice to a buyer, by:
providing an online marketplace between buyers and sellers of commercial invoices;
receiving an invoice uploaded by a seller of the invoice;
sending an electronic communication to a BOG named in the uploaded invoice requesting confirmation of the invoice and approval of its sale on the online marketplace;
receiving confirmation of the invoice and approval of the sale of the invoice from the BOG named in the uploaded invoice;
verifying that the invoice is not used for money laundering and verifying identities of the seller and BOG referenced by the invoice;
arranged trade credit insurance between the seller and a trade credit insurer;
conducting an auction for the purchase of the invoice among one or more buyers;
ending the auction and collecting cash proceeds of a sale of the invoice from one or more winning buyers of the invoice;
retaining at least one sales commission from the cash proceeds;
paying an insurance premium to the trade credit insurer; and
paying a portion of the cash proceeds to the seller.

7. A method of financing an invoice, comprising the steps of:
placing a receivable in the form of an invoice issued by a seller, the invoice having an amount payable by a buyer of goods or services (BOG) up for auction to a plurality of bidders;
receiving bids for at least part of the amount payable, wherein each bid includes an amount a bidder in the plurality of bidders is willing to provide to the seller as well as an interest yield expressed as a percentage of the amount of the bid that the bidder expects to receive at a future date in addition to the bid amount; and
appointing winners of the auction based on lowest interest yield percentages for bids received that satisfy the amount payable.
